(19) United States
(12) Patent Application Publication
(10) Pub. No.: US 2008/0313063 A1
(43) Pub. Date: Dec. 18, 2008

(54) Expense Report Generation From Confirmation Emails

(75) Inventors: James Testa, Palo Alto, CA (US); Nina Holly, Palo Alto, CA (US)

Correspondence Address: AERENDE, INC., PMB 518, 555 BRYANT ST., PALO ALTO, CA, 94301, US

(73) Assignee: WEBSITES BY JOVE., AN LLC, PALO ALTO, CA (US)

(21) Appl. No.: 12/186,131

(22) Filed: Aug. 5, 2008

(51) Int. Cl. G06Q 30/00

(52) U.S. Cl. 705/30

(57) ABSTRACT

Inter alia, methods, and means for automatically generated travel expense reports. One embodiment identifies an email extractor that reads travel expense information from travel reservation booking emails. The extracted information is then displayed in electronic table format. The displayed information includes travel expense details such as vendor name, trip conveyance, date of reservation/expense, accommodation name, cost, currency, etc. The expense report can be accessed and edited by the user, if desired. The user can view and download the report in other formats, such as a spreadsheet.

### CROSS-REFERENCE TO RELATED APPLICATIONS

Patent Application: US 20050222854—Automatically processing an expense report using an expense report agent
Patent Application US 20080103822—Pharmaceutical representative expense report management software, systems, and methodologies
U.S. Pat. No. 4,852,000—Method for expense report storage and calculation

### TECHNICAL FIELD

One embodiment of the invention especially relates to websites that provide expense report generation, and one embodiment relates to websites that provide expense report generation from users supplied data in confirmation emails. One embodiment relates to websites that extract user's travel information from confirmation emails, including cost of travel/accommodations and organize the user's travel information into an expense report.

### BACKGROUND

A major difficulty with travel, especially business travel, is that reservations and accommodations are booked via numerous vendors, and it is difficult to determine what the exact expenses are for a trip. This is even more difficult when traveling for business, where the traveler is reimbursed for the expenses of the trip after providing an expense report to their employer. Typically, generating this expense report consists of the business traveler saving each receipt from the trip and entering each receipt manually into a form, such as a spreadsheet. Currently, most vendors provide confirmation emails for booked reservations, and the present invention generates an expense report from these confirmation emails. This process saves the business traveler the time of entering the travel receipt information manually.

### PRIOR ART

One known approach for calculating expense reports is described in Wayne A. Webb, et al “Method for expense report storage and calculation”, U.S. Pat. No. 4,852,000. This patent describes a method of providing a manual data input method for generating an expense report. A limitation of this patent is that it does not describe a program that can accept travel data in electronic format and extract the relevant data to automatically input into an expense report.

Another known approach with respect to expense reports is described in Jonathon Dale, US Patent Application US20050222854, “Automatically processing an expense report using an expense report agent”. This application describes a method for processing an expense report comprising receiving at an expense report agent a transaction identifier. This transaction identifier is then returned to the retailer system that generated it to receive the transaction information. The limitation of this approach is that a method is not described where the transaction information is first received without having to return a transaction identifier. Another limitation of this approach is that even though the transaction information is in a machine readable format, the method does not describe extracting information that can be put into an expense report from the transaction information.

Another known approach with respect to expense reports is described in Puneet Arora, et al, “Pharmaceutical representative expense report management software, systems and methodologies”. This application describes a computer assisted method for generating an expense report with one or more health care providers, (HCP). A limitation of this application is that it does not describe extracting the expense report information from the information provided by the HCP into a format that is needed for the expense report.

### OBJECTS AND ADVANTAGES

The Expense Report Generation from Confirmation Emails has the following main advantages:
1) the travel information that is input into the expense report comes from the confirmation emails from vendors, which precludes having the user input the expense information manually, eliminating the possibility of erroneous or missed entries,
2) expenses in multiple currencies can be entered in the expense report and the total costs are separated into separate totals per currency,
3) the exchange rate of the currency into dollars can be determined based on the date of the transaction, so that a total for all transactions in the expense report can be determined in terms of a single desired currency.

### SUMMARY

Inter alia, methods, and means for travel expense report generation from confirmation emails. One embodiment identifies an expense report in electronic format populated with information from travel reservation email confirmations. A computer program analyzes said emails for expense information, such as the nature of the expense, date incurred, cost, currency, etc. The information is then input into an electronic format, for example, HTML, that can be accessed and edited by the user, if desired. The user can then view and download the report in different formats, such as a spreadsheet.

### BRIEF DESCRIPTION OF THE DRAWINGS

The appended claims set forth the features of the expense report generation from confirmation emails with particularity. The expense report generation from confirmation emails, together with its advantages, may be best understood from the following detailed description taken in conjunction with the accompanying drawings of which:

FIG. 1 illustrates the databases used to store the information in the confirmation emails, and from which is extracted the information that is displayed in the expense report generated from the confirmation emails.

FIG. 2 illustrates in one embodiment the expenses information is displayed in the expense report. Of particular note are the multiple totals for the different currencies that the expenses were paid in Also included are the discount rate and the percent of each item that was for business (the remainder being for personal use). Further there is a column showing the currency conversion of the expense to a preferred currency, which is accurate for that day.

### DETAILED DESCRIPTION

Inter alia, methods, means and apparatus are disclosed for generating expense reports from confirmation emails. One embodiment of the expense report generation from confirmation emails especially relates to communications and computer systems.

Embodiments described herein include various elements and limitations, with no one element or limitation contemplated as being a critical element or limitation. Each of the claims individually recites an aspect of the expense report generation from confirmation emails in its entirety. Moreover, some embodiments described may include, but are not limited to, inter alia, systems, networks, integrated circuit chips, embedded processors, ASICs, methods and computer-readable medium containing instructions. The embodiments described hereinafter embody various aspects and configurations within the scope and spirit of the expense report generation from confirmation emails, with the Figs illustrating exemplary and non-limiting configurations.

The term “system” is used generally herein to describe any number of components, elements, systems, devices, packet switch elements, packet switches, routers, networks, computer and/or communication devices or mechanisms, or combinations of components thereof. The term “computer” is used generically herein to describe any number of computers, including, but not limited to personal computers, embedded processing elements and systems, control logic, ASICs, chips, workstations, mainframes, etc. The term “processing element” is used generically herein to describe any type of processing mechanism or devices, such as a processor, ASIC, field programmable gate array, computer, etc. The term “device” is used generically herein to describe any type of mechanism, including a computer or system or component thereof. The terms “task” and “process” are used generically herein to describe any type of running program, including, but not limited to a computer process, task, thread, executing application, operating system, user process, device driver, native code, machine or other language, etc., and can be interactive and/or non-interactive, executing locally and/or remotely, executing in foreground and/or background, executing in the user and/or operating system address spaces, a routine of a library and/or standalone application, and is not limited to any particular memory partitioning technique. The steps, connections, and processing of signals and information illustrated in the Figs, including, but not limited to any block and flow diagrams and message sequence charts, may be performed in the same or in a different serial or parallel ordering and/or by different components and/or processes, threads, etc., and/or over different connections and be combined with other functions in other embodiments n keeping within the scope and spirit of the expense report generation from confirmation emails. Furthermore, the term “identify” is used generically to describe any manner or mechanism for directly or indirectly ascertaining something, which may include but is not limited to receiving, retrieving ROM memory, determining, defining, calculating, generating, etc.

Moreover, the terms “network” and “communications mechanism” are used generically herein to describe one or more networks, communications mediums or communications systems, including, but not limited to the Internet, private or public telephone, cellular, wireless, satellite, cable, local area, metropolitan area and/or wide area networks, a cable electrical connection, bus, etc., and internal communications mechanisms such as message passing, inter-process communications, shared memory, etc. The term “message” I used generically herein to describe a piece of information which may or may not be, but is typically communicated via one or more communication mechanisms of any type.

The term “storage mechanism” includes any type of memory, storage device or other mechanism for maintaining instructions or data in any format. “Computer readable medium” is an extensible term including any memory, storage device, storage mechanism, and other storage and signaling mechanisms including interfaces and devices such as network interface cards and buffers therein, a well as any communications devices and signals received and transmitted, and other current and evolving technologies that a computerized system can interpret, receive, and/or transmit. The term “memory” includes any random access memory (RAM), read only memory (ROM), flash memory, integrated circuits, and/or other memory components or elements. The term “storage device” includes any solid state storage media, disk drivers, diskettes, networked services, tape drives, and other storage devices. Memories and storage devices may store computer-executable instructions to be executed by a processing element and/or control logic, and data which is manipulated by a processing element and/or control logic. The term “data structure” is an extensible term referring to any data element, variable, data structure, database, and/or one or more organizational schemes that can be applied to data to facilitate interpreting the data or performing operations on it, such as, but not limited to memory locations or devices, sets, queues, trees, heaps, lists, linked lists, arrays, tables, pointers, etc. A data structure is typically maintained in a storage mechanism. The terms “pointer” and “link” are used generically herein to identify some mechanism for referencing or identifying another element, component, or other entity, and these may include, but are not limited to a reference to a memory or other storage mechanism or location therein, an index in a data structure, a value, etc. The term “associate memory” is an extensible term, and refers to all types of known or future developed associative memories, including, but not limited to binary and ternary content addressable memories, hash tables, TRIE and other data structures, etc. Additionally, the term “associative memory unit” may include, but it not limited to one or more associative memory devices or parts thereof, including, but not limited to regions, segments, banks, pages, blocks, sets of entries, etc.

The term “one embodiment” is used herein to reference a particular embodiment, wherein each reference to “one embodiment” may refer to a different embodiment, and the use of the term repeatedly herein in describing associated features, elements and/or limitations does not establish a cumulative set of associated features, elements and/or limitations that each and every embodiment must include, although an embodiment typically may include all these features, elements and/or limitations. In addition, the phrase “means for xxx” typically includes computer-readable medium containing computer-executable instructions for performing xxx.

In addition, the terms “first”, “second”, etc. are typically used herein to denote different units (e.g., a first element, a second element). The use of these terms herein does not necessarily connote an ordering such as one unit or event occurring or coming before another, but rather provides a mechanism to distinguish between particular units. Additionally, the use of the singular tense of a noun I non-limiting, with its use typically including one or more of the particular thing rather than just one (e.g., the use of the word “memory” typically refers to one or more memories without having to specify “memory or memories” or “one or more memories” or “at least one memory”, etc.). Moreover, the phrases “based on x” and “in response to x” are used to indicate a minimum set of items x from which something is derived or caused, wherein “x” is extensible and does not necessarily describe a complete list of items on which the operations is performed, etc. Additionally, the phrase “coupled to” is used to indicate some level of direct or indirect connections between two elements or devices, with the coupling device or devices modifying or not modifying the coupled signal or communicated information. The term “subset” is used to indicate a group of all or less than all of the elements of a set. The term “or” is used herein to identify a selection of one or more, including all, of the conjunctive items.

### Preferred Embodiment

Expense report generation from confirmation emails is of particular use for business travelers. Business travelers can book airline flights, hotel accommodations, car rentals, boat and train tickets on the Internet. The travel and accommodations vendors provide a receipt to the traveler for the travel/accommodations booked over the Internet via a confirmation email. Confirmation emails vary by vendor. The business traveler is usually compensated by their employer for their travel expenses, after the business traveler has presented to their employer an expense report listed their expenses, the costs and how much of the expenses are for business or pleasure. These expense reports are usually created manually by the business traveler.

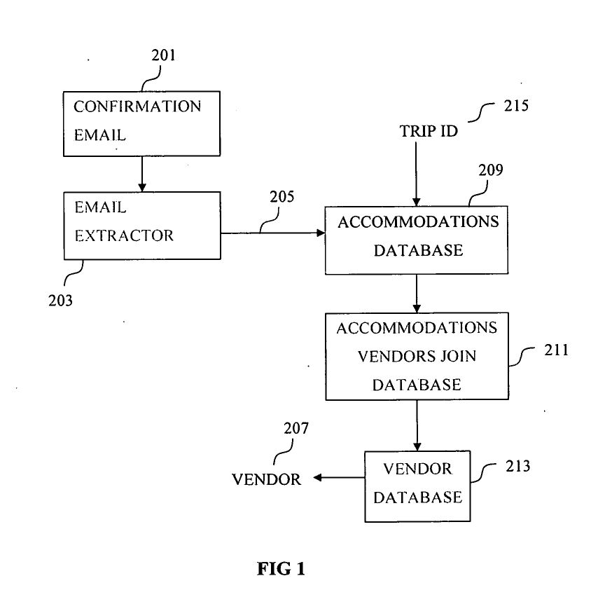

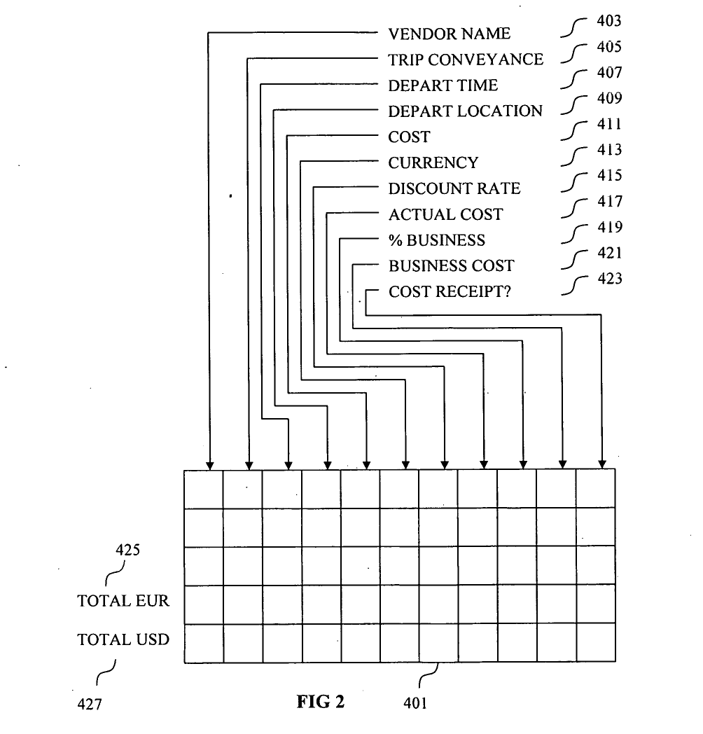

One embodiment of expense report generation from confirmation emails creates an expense report from the confirmation emails from the vendors. The method for extracting the information in the confirmation emails is shown in FIG. 1 and the expense report is shown in FIG. 2. As shown in FIG. 1, the relevant information in each vendors confirmation email, 201, is extracted by the email extractor, 203, and placed in the accommodations database, 209. The email extractor determines which vendor the confirmation email is from and based on the knowledge of the vendor knows where in the email to find the information to extract. The accommodation ID for this confirmation email is placed into an entry in the accommodations_vendors join database, 211, along with the vendor ID of the vendor for this confirmation email. The information extracted by the email extractor from the confirmation email, that is sent to the accommodations database, 205, can contain information for the following fields:

1) Vendor name

2) Trip conveyance (flight, train, boat, hotel, car, etc.)

3) Depart Time

4) Depart Location

5) Cost

6) Currency

7) Discount Rate

8) % for business

9) Cost Receipt?

The expense report is generated per trip by providing the trip ID, 215, as the search criteria to the accommodations database whereby all of the accommodations for that trip ID will be returned. For each accommodation returned, the corresponding accommodation ID is sent to the accommodations_vendors join table, which will be used to address the vendor database. The vendor database will then return the vendor name for the vendor used for that accommodation. In the list below the actual cost is calculated by multiplying the cost by 1−discount rate. The business cost is calculated by multiplying the actual cost by the field “% used for business”. In this manner the fields in the list below are obtained.

A) Vendor name

B) Trip conveyance (flight, train, boat, hotel, car, etc.)

C) Depart Time

D) Depart Location

E) Cost

F) Currency

G) Discount Rate

H) Actual Cost

I) % for business

J) Business cost

K) Cost Receipt Present (yes/no)

FIG. 2 illustrates in one embodiment, an expense report, 401, that lists each of the above items in separate columns, 403 to 423. Furthermore on the bottom of the spreadsheet are the totals for each of the different currencies found in the expenses in the expense report, for example the total for euros, 425, and the total for US dollars, 427.

The user can select the preferred currency, and the expenses that are in other currencies will be converted into the cost in the preferred currency based on the historical currency conversion rates for those two currencies on the date the expense was paid for. The total for that currency will show the total cost of all of the expenses regardless of which currency the expense was created in.

### Alternative Embodiments

An alternative embodiment is to use the double entry approach for the format for the expense report. In this case, there would be a total on the right most column which summed up the expenses for each row. There would also be a total at the bottom of each column that would have the total for each column. Finally, the bottom right hand corner has the sum of the right most column which should equal the sum of all of the columns. Oftentimes the columns need to be placed in separate sections of income tax forms, and the double entry approach is useful to provide separate sums for each column which can be directly placed in the appropriate line item in the income tax forms.

An alternative embodiment is where there is a trip database, where each entry in the trip database contains a user ID and a trip ID, and the accommodations database contains a trip ID. Thus the user can select a trip from the trip database and the trip database provides a trip ID. The accommodations database can then be searched for all accommodations that have that trip ID, i.e. that correspond to that trip.

### CONCLUSION, RAMIFICATIONS AND SCOPE

In view of the possible embodiments to which the principles of generating travel expense reports may be applied, one will appreciate that the embodiments and aspects thereof described herein with respect to the drawings/figures are only illustrative and should not be taken as limiting the scope of automatically generated travel expense reports. For example, and as would be apparent to one skilled in the art, many combinations of data points can be included in such travel expense reports.

The automatically generated travel expense report, as described herein, contemplates all such embodiments as may come within the scope of the following claims and equivalents thereof.

What is claimed is:

1. In combination:
(a) an email extractor for extracting information from vendor's confirmation emails, and
(b) a database of travel accommodations where the information extracted from the vendor's confirmation emails is stored, and
(c) means for generating an expense report from the information extracted from the vendor's confirmation emails that is stored in the accommodations.

2. The means for generating an expense report from confirmation emails according to claim 1, further including
(a) a vendor database, and
(b) an accommodations_vendors database, and
(c) a means for associating accommodations with vendors so that the vendor can be displayed in the row entries of the expense report.

3. The means for generating an expense report from confirmation emails according to claim 1, further including
(a) a trip database containing a user ID and a trip ID,
(b) an accommodations database containing a trip ID, and
(c) a means for selecting a trip with a corresponding user's ID, and selecting all of the accommodations with that trip ID, and displaying the information in those accommodations in an expense report.

4. The means for generating an expense report from confirmation emails according to claim 1, further including a means for summing up the costs of each entry that is associated with a given currency and placing that sum per currency on a separate line.

5. The means for generating an expense report from confirmation emails according to claim 1, further including a means for converting an price entry in a non-preferred currency in the expense report into a preferred currency based on the historical currency conversion rate for those two currencies on the date that the expense was incurred.
